(19) United States
(12) Patent Application Publication
(10) Pub. No.: US 2024/0145130 A1
(43) Pub. Date: May 2, 2024

(54) TWISTED PAIR COMMUNICATION CABLES SUITABLE FOR POWER OVER ETHERNET APPLICATIONS

(71) Applicant: Superior Essex International Inc., Atlanta, GA (US)

(72) Inventors: Christopher W. McNutt, Woodstock, GA (US); Amir Sekhavat, Marietta, GA (US)

(21) Appl. No.: 17/973,942

(22) Filed: Oct. 26, 2022

(51) Int. Cl. H01B 11/12; H01R 13/6463

(52) U.S. Cl. CPC H01B 11/12; H01R 13/6463; H01R 24/64

(57) ABSTRACT

A cable suitable for use in a Power over Ethernet application may include four twisted pairs of individually insulated conductors and a jacket formed around the four twisted pairs. Each of the four twisted pairs may include two conductors having a size greater than or equal to a 19 American Wire Gauge conductor. Additionally, the four twisted pairs may be electrically connected to an RJ-45 connector. Further, the cable may have a longitudinal length greater than 100 m.

### TECHNICAL FIELD

Embodiments of the disclosure relate generally to communication cables and, more particularly, to twisted pair communication suitable for Power over Ethernet applications.

### BACKGROUND

A wide variety of different types of communication cables are utilized to transmit information. For example, twisted pair communication cables are utilized to transmit Ethernet and other data signals in accordance with one or more suitable Category cabling standards. In certain applications, twisted pair cables are utilized to provide both data signals and electrical power to a wide variety of devices, such as security cameras, lighting devices, wireless access points, etc. Typically, electrical power is provided over twisted pairs in accordance with a Power over Ethernet (“PoE”) standard.

Conventional twisted pair cables utilized for PoE applications typically include 23 American Wire Gauge or 24 AWG conductors. These conventional cables are typically Category cables (i.e., Category 5, Category 5e, Category 6, or Category 6A) that have been optimized to satisfy the requirements of applicable industry standards, such as Telecommunications Industry Associations (“TIA”) that limit a maximum distance of Category cables to 100 m. However, there is an opportunity for improved twisted pair communication cables suitable for PoE applications with installation lengths greater than 100 m. In particular, there is an opportunity for twisted pair communication cables that incorporate larger conductors that facilitate transmission of signals over greater distances.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items; however, various embodiments may utilize elements and/or components other than those illustrated in the figures. Additionally, the drawings are provided to illustrate example embodiments described herein and are not intended to limit the scope of the disclosure.

FIGS. 1-3 are cross-sectional views of example twisted pair cables that may be suitable for Power over Ethernet applications, according to an illustrative embodiment of the disclosure.

FIG. 4 illustrates example twist lays that may be utilized for a plurality of twisted pairs incorporated into a cable, according to an illustrative embodiment of the disclosure.

FIG. 5 is a cross-sectional view of example twist directions and an example overall bunch direction that may be utilized for a plurality of twisted pairs incorporated into a cable, according to an illustrative embodiment of the disclosure.

FIGS. 6A-6C are cross-sectional views of example shield layers that may be incorporated into a cable, according to an illustrative embodiment of the disclosure.

FIGS. 7A-7C are top-level views of example patch configurations that may be utilized in accordance with various discontinuous shields, according to an illustrative embodiment of the disclosure.

FIGS. 8-10 are perspective views of example RJ-45 connectors at which twisted pair cables may be electrically terminated, according to illustrative embodiments of the disclosure.

### DETAILED DESCRIPTION

Various embodiments of the present disclosure are directed to twisted pair cables that include conductors that are larger than conventional cables and capable of transmitting signals over longer distances. The twisted pair cables may be utilized for a wide variety of suitable applications, such as Power over Ethernet (“PoE”) applications. Additionally, the twisted pair cables may be designed for and/or installed at a wide variety of suitable distances or longitudinal lengths. For example, in certain embodiments, twisted pair cables may be installed at longitudinal lengths that are greater than 100 meters. In other embodiments, twisted pair cables may be installed at longitudinally lengths that are less than or equal to 100 meters and/or lengths that satisfy applicable Category cabling standards, such as the TIA 568.2-D standard set forth by the Telecommunications Industry Association.

In certain example embodiments, a cable may include a plurality of twisted pairs of individually insulated conductors, such as four twisted pairs of conductors, and a jacket formed around the plurality of twisted pairs. Additionally, each of the four twisted pairs may include two conductors having a size larger than that of conventional twisted pair cables. For example, each twisted pair may include conductors having a size greater than or equal to a 19 American Wire Gauge (“AWG”) conductor. As another example, each twisted pair may include conductors having a size greater than or equal to an 18 AWG conductor. In certain example embodiments, each twisted pair may include conductors having diameters greater than or equal to 0.0359 inches. In other example embodiments, each twisted pair may include conductors having diameters greater than or equal to 0.0403 inches. Additionally, in certain embodiments, the four twisted pairs may be configured to transmit 100 Watts at 1.0 ampere per pair over a distance of at least 100 meters. Further, in certain embodiments, the cable may have an outer diameter that is less than 10 mm. According to an aspect of the disclosure, the cable may also have a longitudinal length that is greater than 100 m, and the larger conductors may facilitate more efficient transmission of power and/or data signals over the longitudinal length of the cable.

According to an aspect of the disclosure, the four twisted pairs are also electrically connected to an RJ-45 connector. In certain embodiments, the RJ-45 connector may include a termination block positioned within the housing of the connector, and the twisted pairs may be terminated at the termination block. In other words, the twisted pairs may be directly connected to and terminated at the RJ-45 connector. As desired, the RJ-45 connector may be adapted or specially designed to facilitate the termination of larger conductors within its housing while still being capable of being plugged into standard plugs or jacks. In other embodiments, the twisted pairs may be terminated at an adapter that is plugged into or otherwise connected to the RJ-45 connector. For example, the adapter may include a termination block that is sized to facilitate termination or connectors of the conductors of the twisted pairs to the adapter. Additionally, the adapter may include a plug that is configured to be inserted into or connected to the RJ-45 connector. In yet other embodiments, a jumper cable may be utilized to facilitate connection of the cable to the RJ-45 connector. For example, a plug, adapter, or termination block may be positioned at one end of the jumper cable, and the twisted pairs may be terminated at the plug, adapter, or termination block. An opposite or distal end of the jumper cable may then be terminated at the RJ-45 connector. In certain embodiments, the jumper cable may include twisted pairs and/or conductors that are sized to be terminated at the RJ-45 connector.

As a result of incorporating larger conductors (e.g., 19 AWG, 18 AWG, or larger conductors), a twisted pair cable may be optimized to carry desired data and power signals (e.g., PoE signals) over a greater distance than conventional twisted pair cables, such as conventional Category cables. More specifically, the twisted pair cable may be optimized to transmit desired signals over a longitudinal length greater than 100 m, such as a length of up to 200 m, 300 m, or greater.

Embodiments of the disclosure now will be described more fully hereinafter with reference to the accompanying drawings, in which certain embodiments of the disclosure are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

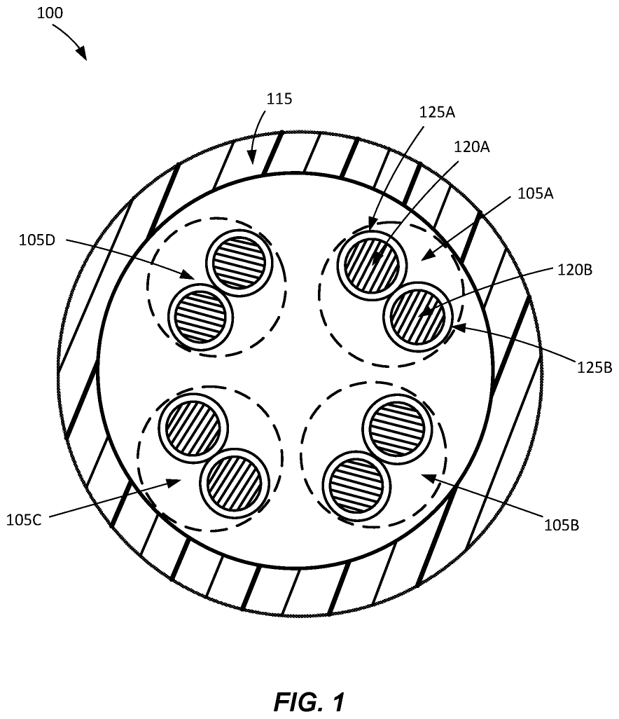

FIGS. 1-3 illustrate a few examples of twisted pair communication cables that may be suitable for extended length PoE and/or other applications, according to various embodiments of the disclosure. As illustrated, the example cables include a wide variety of suitable constructions with different components, such as twisted pairs, separators, shielding elements, pulling elements, heat dissipation elements, etc. The cable components illustrated in any of the cables of FIGS. 1-3, as well as other suitable configurations or constructions described herein, may be combined in any suitable manner in other embodiments of the disclosure. Indeed, the cables illustrated in FIGS. 1-3 are provided by way of non-limiting example only.

The example cables of FIGS. 1-3 may be suitable for use in a wide variety of applications including, but not limited to, indoor, outdoor, plenum, and/or riser applications. In certain embodiments, the cables may be suitable for use in Category cabling applications, such as Category 5, Category 5e, Category 6, Category 6A, or Category 8 applications. In other embodiments, the cables may be suitable for use in Power over Ethernet (“PoE”) applications. In other embodiments, a cable may be suitable for use in both a PoE and a Category cabling application. An intended application for a cable may be defined by one or more suitable industry standards, such as the ANSI/TIA 568.2-D standard or an Institute for Electrical and Electronic Engineers (“IEEE”) Power over Ethernet Standard (e.g., IEEE 802.3af, IEEE 802.3at, IEEE 802.3bt, etc.). Additionally, a cable 100 may be suitable for use at a wide variety of suitable distances or longitudinal lengths, such as longitudinal lengths of up to 100 m and/or extended longitudinal lengths of more than 100 m. Certain aspects of a cable, such as the sizes used for various conductors and/or twist lays of the twisted pairs may be engineered such that the cable can satisfy performance requirements associated with one or more applicable industry standards and/or performance requirements associated with a desired application.

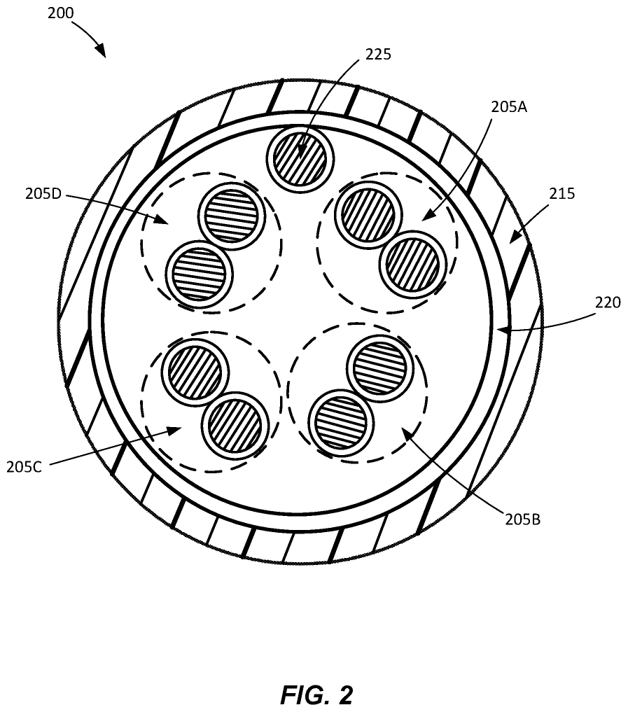

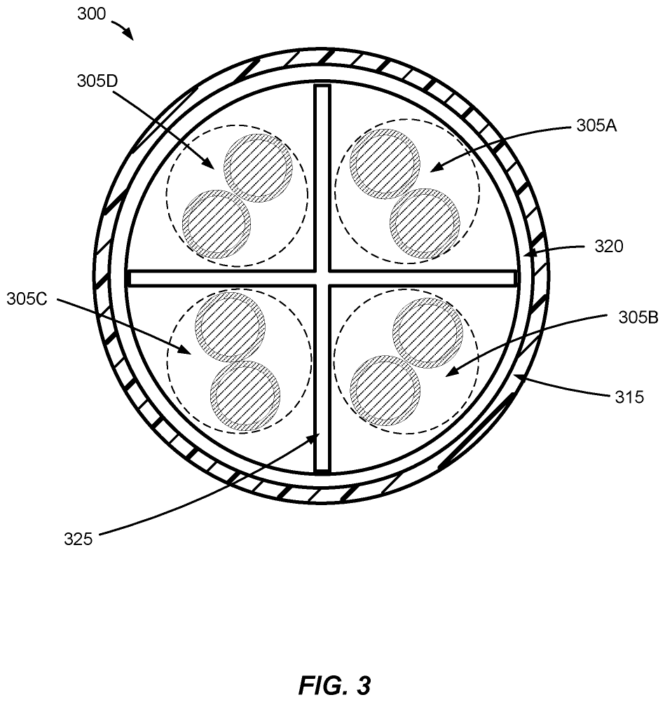

Turning first to FIG. 1, a cross-section of a first example cable 100 suitable for PoE applications, such as extended distance PoE applications, is illustrated. As shown in FIG. 1, the cable 100 may include a plurality of twisted pairs 105A-D of individually insulated conductors and a jacket 115 formed around the twisted pairs 105A-D. A wide variety of other components may optionally be incorporated into the cable 100 as desired in various embodiments, such as a separator, one or more shielding elements, one or more pulling elements, one or more heat dissipation elements, one or more rip cords, one or more drain wires, etc. Certain optional components that may be incorporated into the cable 100 are described in greater detail below and illustrated with reference to other example cables included in FIGS. 2-3. Each of the components of the cable 100 will now be described in greater detail.

According to an aspect of the disclosure, the cable 100 may include a plurality of twisted pairs of individually insulated conductors. As shown in FIG. 1, the cable 100 may include four twisted pairs 105A, 105B, 105C, 105D; however, other suitable numbers of pairs may be utilized in other embodiments. Each twisted pair (referred to generally as twisted pair 105) may include two electrical conductors 120A, 120B, each covered with respective insulation 125A, 125B. The electrical conductors (generally referred to as conductor 120) of a twisted pair 105 may be formed from any suitable electrically conductive material, such as copper, aluminum, silver, annealed copper, gold, a conductive alloy, etc. Additionally, the electrical conductors 120 of each twisted pair 105 may have any suitable diameter, gauge, and/or other dimensions. Further, each of the electrical conductors 120 may be formed as either a solid conductor or as a conductor that includes a plurality of conductive strands that are twisted together.

In certain embodiments, the cable 100 may include only four twisted pairs of individually insulated conductors 105A-D, one or more optional pulling elements and/or heat dissipation elements (as described in greater detail below with reference to FIG. 2), and no other conductive elements and/or transmission media. For example, the cable 100 may include four pairs 105A-D and no other conductive components that are suitable for transmitting communications and/or power signals. As another example, the cable 100 may include four pairs 105A-D, one or more pulling elements and/or heat dissipation elements, one or more optional drain wires, and no other conductive components that are suitable for transmitting communications and/or power signals. As another example, the cable 100 may include four pairs 105A-D, one or more pulling elements and/or heat dissipation elements, and no other components (e.g., conductive components, optical fibers, etc.) that are suitable for transmitting communications and/or power signals. As yet another example, the cable 100 may include four pairs 105A-D, one or more pulling elements and/or heat dissipation elements, one or more drain wires, and no other components (e.g., conductive components, optical fibers, etc.) that are suitable for transmitting communications and/or power signals.

According to an aspect of the disclosure, the cable 100 may include twisted pairs 105A-D with conductors that are sized to be larger than those of conventional twisted pair cables. The larger conductors may facilitate transmission and/or more efficient transmission of power and/or data signals over distances exceeded 100 m. In certain embodiments, each of the twisted pairs 105A-D may include conductors (e.g., conductors 120A, 120B, etc.) that are sized to be greater than or equal to a 19 American Wire Gauge (“AWG”) conductor. In other embodiments, each of the twisted pairs 105A-D may include conductors (e.g., conductors 120A, 120B, etc.) that are sized to be greater than or equal to an 18 AWG conductor. The conductors may be formed with a wide variety of suitable diameters as desired in various embodiments. For example, in certain embodiments, each twisted pair 105A-D may include conductors having diameters greater than or equal to 0.0359 inches. In other embodiments, each twisted pair 105A-D may include conductors having diameters greater than or equal to 0.0403 inches. Other suitable diameters may be utilized as desired in other embodiments. In certain embodiments, the electrical conductors of each twisted pair 105A-D may be sized in accordance with a desired application for the cable 100. For example, in a given PoE application, the conductors of each twisted pair 105A-D may be sized based at least in part upon the available power from a power supply, the requirements of a powered device, the data requirements of a connection and/or connected devices, and/or the longitudinal length of a cable run.

In certain embodiments, the electrical conductors of the twisted pairs 105A-D may be capable of transmitting a desired power signal for PoE applications, such as a desired power signal established by the IEEE 802.3bt Type 4 “4PPoE”/“PoE++” Standard published by the Institute of Electrical and Electronics Engineers (“IEEE”). For example, a desired number of twisted pairs (e.g., the illustrated four twisted pairs 105A-D, etc.) may be capable of transmitting at least approximately 100 Watts of power at approximately 1.0 ampere per pair over a distance of approximately 100 meters. Given the larger conductors of the cable 100, the twisted pairs 105A-D may be capable of transmitting a power signal at distances exceeding 100 m. In certain embodiments, the twisted pairs may be capable of transmitting a power signal at a desired efficiency, such as at least approximately 80, 82, 85, or 88% efficiency at a temperature of approximately twenty degrees Celsius (20° C.). In certain embodiments, each example twisted pair 105 may be capable of transmitting a desired portion of the overall power. For example, each set of two twisted pairs (e.g., twisted pairs 105A-B and 105C-D, etc.) may be capable of transmitting at least approximately 50 Watts of power. The power transmitted by each set of twisted pairs may be equal to the current carried by each twisted pair multiplied by the voltage between the two twisted pairs. The current and/or voltage on/between each twisted pair may be adjusted as desired in order to attain a desired power signal. As one example, each conductor of a twisted pair 105 may carry an approximately 0.5 ampere signal. Thus, a combined signal of approximately 1.0 ampere may be transmitted on a twisted pair. Other suitable power transmission requirements may be utilized as desired in other embodiments.

Additionally, each twisted pair 105 may be configured to carry data or some other form of information, for example in a range of about one to ten Giga bits per second (“Gbps”) or other suitable data rates, whether higher or lower. In certain embodiments, each twisted pair 105 may support data transmission of about two and one-half Gbps (e.g. nominally two and one-half Gbps), with the cable 100 supporting about ten Gbps (e.g. nominally ten Gbps). In certain embodiments, each twisted pair 105 may support data transmission of up to about ten Gbps (e.g. nominally ten Gbps), with the cable 100 supporting about forty Gbps (e.g. nominally forty Gbps). Other suitable data transmission capabilities may be utilized as desired in other embodiments.

The twisted pair insulation (generally referred to as insulation 125) may include any suitable dielectric materials and/or combination of materials. Examples of suitable dielectric materials include, but are not limited to, one or more polymeric materials, one or more polyolefins (e.g., polyethylene, polypropylene, etc.), one or more fluoropolymers (e.g., fluorinated ethylene propylene (“FEP”), melt processable fluoropolymers, MFA, PFA, ethylene tetrafluoroethylene (“ETFE”), ethylene chlorotrifluoroethylene (“ECTFE”), etc.), one or more polyesters, polyvinyl chloride (“PVC”), one or more flame retardant olefins, a low smoke zero halogen (“LSZH”) material, etc.), polyurethane, neoprene, cholorosulphonated polyethylene, flame retardant PVC, low temperature oil resistant PVC, flame retardant polyurethane, flexible PVC, or a combination of any of the above materials. Additionally, in certain embodiments, the insulation of each of the electrical conductors utilized in the twisted pairs 105A-D may be formed from similar materials. In other embodiments, at least two of the twisted pairs may utilize different insulation materials. In yet other embodiments, the two conductors that make up a twisted pair 105 may utilize different insulation materials. As desired in certain embodiments, insulation may additionally include a wide variety of other materials (e.g., filler materials, materials compounded or mixed with a base insulation material, etc.), such as smoke suppressant materials, flame retardant materials, etc.

In various embodiments, twisted pair insulation 125 may be formed from one or multiple layers of insulation material. A layer of insulation may be formed as solid insulation, unfoamed insulation, foamed insulation, or other suitable insulation. As desired, a combination of different types of insulation may be utilized. For example, a foamed insulation layer may be covered with a solid foam skin layer. As desired with foamed insulation, different foaming levels may be utilized for different twisted pairs in accordance with twist lay length to assist in balancing propagation delays between the twisted pairs. Additionally, the twisted pair insulation 125 may be formed with any suitable thickness, inner diameter, outer diameter, and/or other dimensions.

In various embodiments, a desired number of the twisted pairs 105A-D may be formed with different respective twist lays. The different twist lays may function to reduce crosstalk between the twisted pairs 105A-D, and a wide variety of suitable twist lay configurations may be utilized. In certain embodiments, at least two of the twisted pairs 105A-D incorporated into a cable 100 may be formed with different twist lays. For example, a first twisted pair 105A and a second twisted pair 105B incorporated into the cable 100 may have different twist lays. In other embodiments, each of the twisted pairs 105A-D incorporated into the cable 100 may have a different twist lay.

In certain embodiments, the respective twist lays for the twisted pairs 105A-D may be selected, calculated, or determined in order to result in a cable 100 that satisfies one or more power delivery requirements (e.g., PoE power delivery requirements for an application), electrical requirements, and/or standards. For example, twist lays may be selected such that the cable 100 can deliver a 100 W or other desired power signal over a desired longitudinal length of the cable 100, such as 100 m or an extended length that is greater than 100 m (e.g., 110 m, 125 m, 150 m, 200 m, 250 m, etc.). As another example, twist lays may be selected such that the cable 100 satisfies one or more electrical requirements of a Category 5, Category 5e, Category 6, Category 6A or other suitable Category cabling standard, such as the TIA 568.2-D standard set forth by the Telecommunications Industry Association. Twist lays may be selected as desired such that the cable 100 satisfies a wide variety of other electrical requirements, such as a propagation delay skew of less than approximately forty-five nanoseconds (45 ns) per one hundred meters (100 m) and/or a direct current resistance unbalance between any pairs (i.e., any two pairs of the cable 100) of less than approximately one hundred milliohms (100 mΩ) per one hundred meters (100 m).

In certain embodiments, the differences between twist lays of twisted pairs that are circumferentially adjacent one another (for example the twisted pair 105A and the twisted pair 105B) may be greater than the differences between twist lays of twisted pairs that are diagonal from one another (for example the twisted pair 105A and the twisted pair 105C). As a result of having similar twist lays, the twisted pairs that are diagonally disposed can be more susceptible to crosstalk issues than the twisted pairs 105 that are circumferentially adjacent; however, the distance between the diagonally disposed pairs may limit the crosstalk. Thus, the different twist lays and arrangements of the pairs can help reduce crosstalk among the twisted pairs 105.

As desired, the plurality of twisted pairs 105A-D may be twisted together with an overall twist or bunch. Any suitable overall twist lay or bunch lay may be utilized, such as a bunch lay between approximately 1.9 inches and approximately 15.0 inches. For example, a bunch lay may be approximately 1.9, 2.0, 2.5, 3.0, 3.5, 3.75, 4.0, 4.25, 4.5, 4.75, 5.0, 5.5, 6.0, 7.0, 7.5, 8.0, 9.0, 10.0, 11.0, 12.0, or 15.0 inches, or any value included in a range between two of the previously listed values (e.g., a bunch lay between approximately 3.5 and approximately 4.5 inches, etc.), or any value included in a range bounded on either a minimum or maximum end by one of the above values (e.g., a bunch lay that is less than or equal to approximately 4.25 inches, etc.).

In certain embodiments, the twisted pairs 105A-D may each be twisted in the same direction (e.g., clockwise, counter-clockwise). An overall twist or bunching may then be formed in the same direction as the twisted pairs 105A-D (which tends to tighten the twist lays of each pair) or, alternatively, in an opposite direction from the twisted pairs (which tends to loosen the twist lays of each pair). In other embodiments, a first portion of the twisted pairs 105A-D may have a twist direction that is the same as the overall twist direction while a second portion of the twisted pairs 105A-D may have a twist direction that is opposite that of the overall twist direction. Any number of twisted pairs may be included in either the first portion or the second portion. Indeed, a wide variety of suitable combinations of twist lays and/or twist directions may be utilized as desired in order to obtain twisted pairs with desired final or resultant twist lays. As desired in various embodiments, one or more suitable bindings or wraps may be wrapped or otherwise formed around the twisted pairs 105A-D once they are twisted together.

With continued reference to FIG. 1, a jacket 115 may enclose the internal components of the cable 100, seal the cable 100 from the environment, and/or provide strength and structural support. The jacket 115 may be formed from a wide variety of suitable materials and/or combinations of materials, such as one or more polymeric materials, one or more polyolefins (e.g., polyethylene, polypropylene, etc.), one or more fluoropolymers (e.g., fluorinated ethylene propylene (“FEP”), melt processable fluoropolymers, MFA, PFA, ethylene tetrafluoroethylene (“ETFE”), ethylene chlorotrifluoroethylene (“ECTFE”), etc.), one or more polyesters, polyvinyl chloride (“PVC”), one or more flame retardant olefins (e.g., flame retardant polyethylene (“FRPE”), flame retardant polypropylene (“FRPP”), a low smoke zero halogen (“LSZH”) material, etc.), polyurethane, neoprene, cholorosulphonated polyethylene, flame retardant PVC, low temperature oil resistant PVC, flame retardant polyurethane, flexible PVC, or a combination of any of the above materials. The jacket 115 may be formed as a single layer or, alternatively, as multiple layers. In certain embodiments, the jacket 115 may be formed from one or more layers of foamed material. As desired, the jacket 115 can include flame retardant and/or smoke suppressant materials. As shown, the jacket 115 may be formed to result in a round cable or a cable having an approximately circular cross-section; however, the jacket 115 and internal components may be formed to result in other desired shapes, such as an elliptical, oval, or rectangular shape. In various embodiments, the jacket 115 can be characterized as an outer jacket, an outer sheath, a casing, a circumferential cover, or a shell.

The jacket 115 may also have a wide variety of suitable dimensions, such as any suitable or desirable outer diameter and/or any suitable or desirable wall thickness. In certain embodiments, the cable 100 may be formed with a relatively small outside or outer diameter. In this regard, the cable 100 may be routed through and/or installed in relatively small spaces. According to an aspect of the disclosure, the cable 100 may have an outside diameter that is less than or equal to approximately 10 mm (0.393 inches). Other suitable outside diameters may be utilized as desired in various embodiments, such as an outside diameter that is less than or equal to approximately 6, 7, 8, 9, or 10 mm, or an outside diameter included in a range between any two of the above values.

An opening enclosed by the jacket 115 may be referred to as a cable core, and the twisted pairs 105A-D and/or other cable components may be disposed within the cable core. Although a single cable core is illustrated in the cable 100 of FIG. 1, a cable may be formed to include multiple cable cores. In certain embodiments, the cable core may be filled with a gas such as air (as illustrated) or alternatively a gelatinous, solid, powder, moisture absorbing material, water-swellable substance, dry filling compound, or foam material, for example in interstitial spaces between the twisted pairs 105A-D and/or other internal cable components. Other elements can be added to the cable core as desired, for example, water absorbing materials, one or more rip cords, and/or one or more drain wires, depending upon application goals.

As desired in various embodiments, a wide variety of other suitable components may be incorporated into the cable 100. Examples of suitable components include, but are not limited to, a separator positioned between the plurality of twisted pairs 105A-D, one or more shielding elements (e.g., an overall shield, individual twisted pair shields, etc.), one or more pulling element, one or more additional conductors (e.g., conductive pulling elements, heat dissipation elements, etc.), a rip cord, one or more drain wires, and/or other suitable components. A few example components, such as a separator, a shielding element, a pulling element, and/or an additional conductor are described in greater detail below with reference to FIGS. 2 and 3. It will be appreciated that these example components can be incorporated into the cable 100 of FIG. 1 in certain embodiments. As desired, a cable 100 may also include a wide variety of water blocking or water swellable materials, insulating materials, dielectric materials, flame retardants, flame suppressants or extinguishants, gels, and/or other materials. The cable 100 illustrated in FIG. 1 is provided by way of example only. Embodiments of the disclosure contemplate a wide variety of other cables and cable constructions. These other cables may include more or less components than the cable 100 illustrated in FIG. 1. Additionally, certain components may have different dimensions and/or materials than the components illustrated in FIG. 1.

FIG. 2 illustrates a cross-sectional view of a second example cable 200 suitable for PoE applications, such as extended distance PoE applications. As shown, the cable 200 may include a plurality of twisted pairs 205A-D of individually insulated conductors and a jacket 215 formed around the twisted pairs 205A-D. Each of these components may be similar to those discussed above with reference to the cable 100 of FIG. 1. Additionally, the cable 200 may include one or more shielding elements, such as the illustrated overall shield 220 formed around the plurality of twisted pairs 205A-D. Other suitable shielding elements may be incorporated into the cable 200 as desired, and example shielding arrangements are described in greater detail below. Further, as shown in FIG. 2 and described in greater detail below, the cable 200 may optionally include one or more pulling elements, heat dissipation elements, and/or additional conductors 225.

Similar to the cable 100 of FIG. 1, the cable 200 of FIG. 2 may include twisted pairs 205A-D having larger conductors than conventional twisted pair cables. For example, each of the twisted pairs 205A-D may have conductors that are sized to be equivalent to or larger than 19 AWG conductors or 18 AWG conductors. As another example, each of the twisted pairs 205A-D may have conductors that have diameters that are greater than or equal to 0.0359 inches, 0.0403 inches, or another suitable diameter. Other suitable conductor sizes may be utilized as desired. Additionally, as described in greater detail above with reference to FIG. 1, a wide variety of suitable twist lays may be utilized in conjunction with the twisted pairs 205A-D of the cable 200 illustrated in FIG. 2.

With continued reference to FIG. 2, the cable 200 is illustrated as including an overall shield layer 220 formed around the plurality of twisted pairs 205A-D. As desired in various embodiments, a wide variety of suitable shield elements or shielding elements may be incorporated into a cable 200. Each shielding element may incorporate one or more shielding materials, such as electrically conductive shielding material, semi-conductive material, and/or dielectric shielding material (e.g., ferrite ceramic material, etc.). Examples of suitable shield layers that may be utilized as shielding elements include, but are not limited to, an overall shield formed around the twisted pairs 205A-D (as shown in FIGS. 2 and 3), individual shield layers respectively formed around each of the twisted pairs 205A-D, one or more shield layers formed around desired subgroups of the twisted pairs 205A-D. Shielding material may also be incorporated into cable separators or fillers positioned between two or more of the pairs 205A-D. Similarly, shielding material may be incorporated into separation elements (e.g., film layers, etc.) that are positioned between the individual conductors of one or more twisted pairs. Indeed, a wide variety of suitable shielding configurations, shield elements, and/or combinations of shield elements may be utilized.

In certain embodiments, a shield layer, such as an overall shield layer, may be positioned within a cable core. In other embodiments, a shield layer may be incorporated into the outer jacket 215. For example, a shield layer may be sandwiched between two other layers of outer jacket material, such as two dielectric layers. As another example, electrically conductive material or other shielding material may be injected or inserted into the outer jacket 215 or, alternatively, the outer jacket 215 may be impregnated with shielding material. A wide variety of other suitable shielding arrangements may be utilized as desired in other embodiments. Further, in certain embodiments, a cable 200 may include a separate, armor layer (e.g., a corrugated armor, etc.) for providing mechanical protection.

An example external or overall shield layer (such as those illustrated in FIGS. 2 and 3) or shield 220 will now be described herein in greater detail; however, it will be appreciated that other shield layers may have similar constructions. In certain embodiments, a shield 220 may be formed from a single segment or portion that extends along a longitudinal length of the cable 200. In other embodiments, a shield 220 may be formed from a plurality of discrete segments or portions positioned adjacent to one another along a longitudinal length of the cable 200. In the event that discrete segments or portions are utilized, in certain embodiments, gaps or spaces may exist between adjacent segments or portions. In other embodiments, certain segments may overlap one another. For example, an overlap may be formed between segments positioned adjacent to one another in a longitudinal direction.

As desired, a wide variety of suitable techniques and/or processes may be utilized to form a shield 220 (or a shield segment). For example, a shield 220 may be formed from continuous electrically conductive material (e.g., an aluminum foil layer, etc.). As another example, a shield 220 may be formed as a braided shield. As yet another example, a base material or dielectric material may be extruded, pultruded, or otherwise formed. Electrically conductive material or other shielding material may then be applied to the base material. In other embodiments, shielding material may be injected into the base material. In other embodiments, dielectric material may be formed or extruded over shielding material in order to form a shield 220. Indeed, a wide variety of suitable techniques may be utilized to incorporate shielding material into a base material.

In certain embodiments, the shield 220 (or individual shield segments) may be formed as a tape that includes both a dielectric layer and an electrically conductive layer (e.g., copper, aluminum, silver, an alloy, etc.) formed on one or both sides of the dielectric layer. Examples of suitable materials that may be used to form a dielectric layer include, but are not limited to, various plastics, one or more polymeric materials, one or more polyolefins (e.g., polyethylene, polypropylene, etc.), one or more fluoropolymers (e.g., fluorinated ethylene propylene (“FEP”), polyester, polytetrafluoroethylene, polyimide, or some other polymer, combination of polymers, aramid materials, or dielectric material(s) that does not ordinarily conduct electricity. In certain embodiments, a separate dielectric layer and electrically conductive layer may be bonded, adhered, or otherwise joined (e.g., glued, etc.) together to form the shield 220. In other embodiments, electrically conductive material may be formed on a dielectric layer via any number of suitable techniques, such as the application of metallic ink or paint, liquid metal deposition, vapor deposition, welding, heat fusion, adherence of patches to the dielectric, or etching of patches from a metallic sheet. In certain embodiments, the conductive patches can be over-coated with an electrically insulating film, such as a polyester coating. Additionally, in certain embodiments, an electrically conductive layer may be sandwiched between two dielectric layers. In other embodiments, at least two electrically conductive layers may be combined with any number of suitable dielectric layers to form the shield 220. For example, a four-layer construction may include respective electrically conductive layers formed on either side of a first dielectric layer. A second dielectric layer may then be formed on one of the electrically conductive layers to provide insulation between the electrically conductive layer and the twisted pairs 205A-D. Indeed, any number of suitable layers of material may be utilized in a shield 220.

As set forth above, a wide variety of different components of a cable may function as shielding elements, such as a shield layer, a separator positioned between a plurality of twisted pairs 205A-D, or dielectric separator positioned between the individual conductors of a twisted pair 205. In certain embodiments, the electrically conductive material or other shielding material incorporated into a shield element may be relatively continuous along a longitudinal length of a cable 200. For example, a relatively continuous foil shield or braided shield may be utilized. In other embodiments, a shield element may be formed as a discontinuous shield element having a plurality of isolated patches of shielding material. For example, a plurality of discontinuous patches of electrically conductive material may be incorporated into the shield element (or into various components of a shield element), and gaps or spaces may be present between adjacent patches in a longitudinal direction. A wide variety of different patch patterns may be formed as desired in various embodiments, and a patch pattern may include a period or definite step. In other embodiments, patches may be randomly formed or situated on a base or carrier layer.

A wide variety of suitable shielding materials may be utilized to form patches of shielding material. Examples of suitable electrically conductive materials that may be utilized include, but not limited to, metallic material (e.g., silver, copper, nickel, steel, iron, annealed copper, gold, aluminum, etc.), metallic alloys, conductive composite materials, etc. Indeed, suitable electrically conductive materials may include any material having an electrical resistivity of less than approximately 1×10⁻⁷ ohm meters at approximately 20° C. In certain embodiments, an electrically conductive material may have an electrical resistivity of less than approximately 3×10⁻⁸ ohm meters at approximately 20° C. Electrically conductive material incorporated into a shield may have any desired thickness, such as a thickness of about 0.5 mils (about 13 microns) or greater.

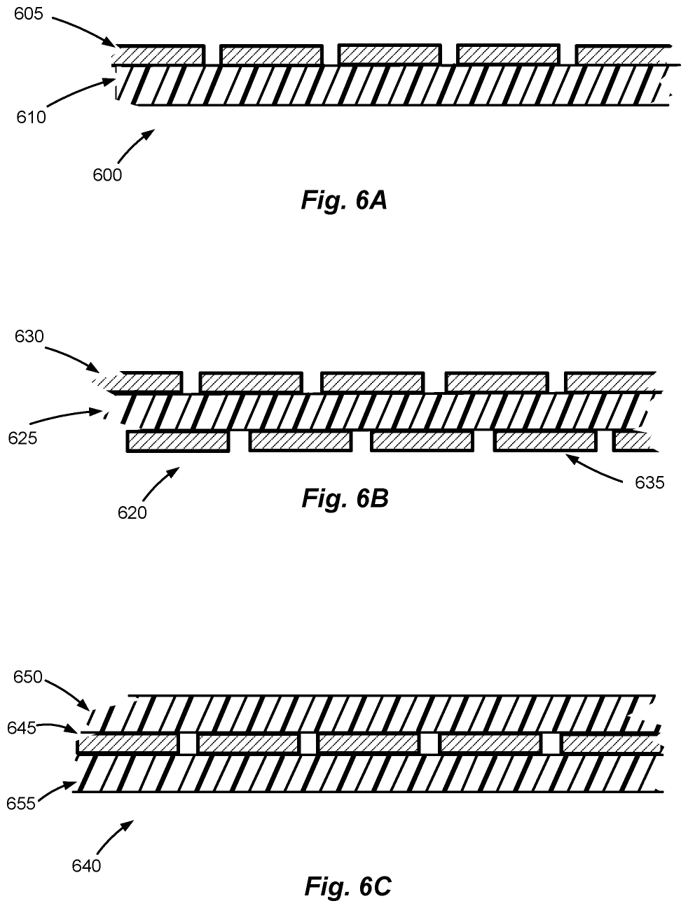

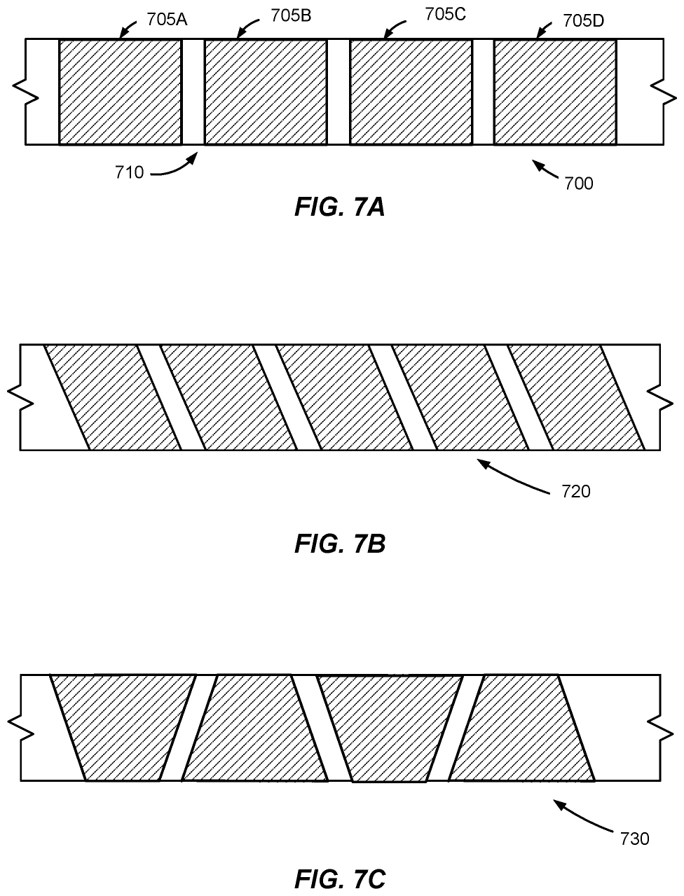

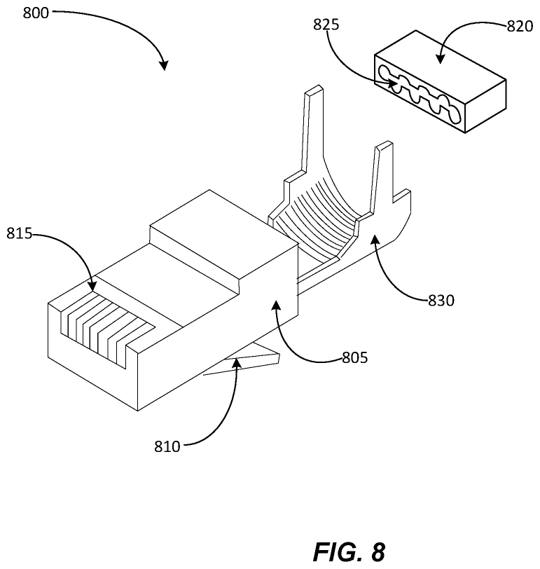

Additionally, for shield elements that include discontinuous or spaced patches of electrically conductive material, a wide variety of suitable patch lengths (e.g., lengths along a longitudinal direction of a cable) may be utilized. As desired, the dimensions of the segments and/or electrically conductive patches can be selected to provide electromagnetic shielding over a specific band of electromagnetic frequencies or above or below a designated frequency threshold. Individual patches may be separated from one another so that each patch is electrically isolated from the other patches. That is, the respective physical separations between the patches may impede the flow of electricity between adjacent patches. In certain embodiments, the physical separation of patches may be formed by gaps or spaces, such as gaps of dielectric material. In other embodiments, the physical separation of certain patches may result from the overlapping of shield segments. For example, a shield element may be formed from a plurality of discrete segments, and adjacent segments may overlap one another. The respective physical separations between the patches may impede the flow of electricity between adjacent patches. A wide variety of suitable gap distances or isolation gaps may be provided between adjacent patches. Additionally, in certain embodiments, patches may be formed as first patches (e.g., first patches on a first side of a dielectric material), and second patches may be formed on an opposite side of a dielectric base layer. For example, second patches may be formed to correspond with the gaps or isolation spaces between the first patches. As desired, patches may have a wide variety of different shapes and/or orientations. For example, the segments and/or patches may have a rectangular, trapezoidal, parallelogram, triangular, or any other desired shape. A few non-limiting examples of shield constructions and patch configurations are described in greater detail below with reference to FIGS. 6A-7C.

With continued reference to FIG. 2, in certain embodiments, one or more additional wires and/or pulling elements (each generally referred to as element 225) may be incorporated into a cable 200 as desired. In certain embodiments, the one or more additional wires 225 may be conductive wires that serve a wide variety of suitable purposes, such as transmission of signals, dissipation of heat within the cable 200 or near devices connected to the cable, grounding or functioning as an electrical drain, and/or functioning as an element that allows an enhanced pulling force to be imparted on the cable. As desired in various embodiments, an additional wire 225 may be a bare uninsulated conductive wire or a wire that includes one or more layers of insulation. In the event that insulation is utilized, a wide variety of suitable types of insulation can be utilized, such as thermoplastic and/or thermoset insulation. In other embodiments and as explained in greater detail below, a pulling element 225 may be formed from dielectric or non-conductive materials.

In other embodiments, the additional wire(s) 225 may be formed as one or more integrated pulling elements. The pulling element(s) 225 may allow a twisted pair cable 200 to withstand greater pulling forces than those permitted by existing cabling standards. For example, the pulling elements may allow a cable 200 to withstand pulling forces greater than 110 Newtons, such as pulling forces of 330 N or greater. As a result, the cable 200 may be easily pulled and installed at longitudinal lengths or distances greater than 100 m without the twisted pairs 205A-D being stretched or elongated. Twisted pair cables with integrated pulling elements may be utilized in a wide variety of suitable applications, such as Category cabling applications, Power over Ethernet (“PoE”) applications, etc.

In the event that a cable 200 includes one or more pulling elements 225, a wide variety of suitable pulling elements 225 may be incorporated into the cable 200 as desired in various embodiments. These pulling elements 225 may be formed from a wide variety of suitable materials and/or with a wide variety of suitable dimensions. In certain embodiments, a metallic pulling element 225 may be utilized such that the pulling element 225 constitutes an additional wire. For example, the pulling element 225 may be formed from steel, titanium, another suitable metal, or a metallic alloy. In other embodiments, the pulling element 225 may be formed from other suitable materials, such as dielectric materials (e.g., glass reinforced plastic, aramid, etc.) and/or semi-conductive materials (e.g., carbon fiber, etc.). In certain embodiments, a pulling element (e.g., a metallic pulling element, etc.) 225 may be formed from a material (e.g., a metallic material, etc.) having a higher elastic modulus than that of the copper or other conductive material utilized in the twisted pairs 205A-D. For example, a pulling element 225 may be formed from a material having an elastic modulus greater than 125 GPa. In this regard, the pulling element 225 may primarily bear the tensile load associated with pulling the cable 200.

An additional wire (e.g., a magnet wire, a pulling element, etc.) 225 may be formed with a wide variety of suitable dimensions, such as any suitable gauge or cross-sectional area. In certain embodiments, a pulling element 225 may be sized in order to allow the cable to withstand a desired pulling force. For example, a pulling element 225 may have a cross-sectional area of at least 0.115 mm 2 . For example, a 26 AWG or larger steel pulling element may be utilized. Additionally, in certain embodiments, an additional wire 225 may be formed from a single component. In other embodiments, an additional wire 225 may be formed from a plurality of components that are stranded or twisted together. For example, an additional wire 225 may be formed with a single conductor or with a plurality of conductive strands. Additionally, in certain embodiments, a bare, uninsulated, or uncoated additional wire 225 may be utilized. In other embodiments, suitable insulation or a suitable coating may be formed on an additional wire. A wide variety of suitable insulation and/or other coating layers may be utilized as desired on an insulated wire including, but not limited to, any of the thermoset materials discussed above, polyethylene (e.g., medium density polyethylene, etc.), polypropylene, one or more other polymeric materials (e.g., such as any of the materials described above with reference to the twisted pair insulation or a cable jacket, etc.), one or more thermoplastic materials, one or more elastomeric materials, an ethylene-acrylic acid (“EAA”) copolymer, ethyl vinyl acetate (“EVA”), etc.

Any number of suitable additional wires (e.g., magnet wires, pulling elements, etc.) 225 may be incorporated into a cable 200 as desired in various embodiments. In certain embodiments, a single additional wire 225 may be utilized. In other embodiments, a plurality (e.g., two, three, four, etc.) of additional wires 225 may be incorporated into a cable 200. In certain embodiments, a plurality of additional wires may have similar constructions. In other embodiments, at least two additional wires may be formed with different materials and/or different dimensions. Additionally, one or more additional wires 225 may be positioned at a wide variety of suitable locations within a cable 200. For example, one or more additional wires 225 may be positioned between the twisted pairs 205A-D and the cable jacket 215 (e.g., around an outer periphery of the twisted pairs 205A-D, etc.). As another example, an additional wire 225 may be positioned between the plurality of twisted pairs 205A-D (e.g., positioned in an interstitial space between the pairs 205A-D, embedded into or positioned within a separator, etc.). As yet another example, one or more additional wires 225 may be embedded within the cable jacket 215. In other embodiments, a plurality of additional wires 225 may be positioned at different locations. For example, a first additional wire may be positioned between the plurality of twisted pairs while a second additional wire is positioned outside an outer periphery of the twisted pairs. Regardless of the positioning of one or more additional wires 225, in certain embodiments, an additional wire 225 may extend in a longitudinal direction parallel to the plurality of the twisted pairs 205A-D. In other words, the additional wire 225 may not be twisted or stranded with the twisted pairs 205A-D. In other embodiments, an additional wire 225 such as a magnet wire may be twisted or otherwise stranded with the plurality of twisted pairs.

A wide variety of benefits may be attained by incorporating one or more additional wires 225 into a twisted pair cable 200. For example, an additional wire 225 may be utilized to transmit a data and/or power signal, to provide a toning element, to dissipate heat within a cable 200, or to provide additional tensile strength. As a result of incorporating one or more pulling elements 225 in certain embodiments, a greater pulling force may be applied or imparted onto the cable 200 without stretching, elongating, or damaging the twisted pairs 205A-D. The ability to pull a twisted pair cable 200 with greater force may facilitate easier installation of cable runs at lengths exceeding the 100 m limit established by industry standards. For example, a four pair cable 200 that can withstand a pulling force of 330 N may be installed at lengths up to approximately 300 m. Additionally, in certain embodiments, one or more additional wires may be incorporated into a twisted pair cable 200 without materially altering an outside diameter of the twisted pair cable 200. For example, a twisted pair cable 200 incorporating one or more additional wires 225 may have an outside diameter less than or equal to approximately 10 mm.

A wide variety of other suitable components may be incorporated into the cable 200 of FIG. 2 as desired in other embodiments. Examples of suitable components include, but are not limited to, a separator positioned between the plurality of twisted pairs 205A-D, additional or alternative shielding elements, a rip cord, one or more drain wires, and/or other suitable components. It will be appreciated that any of the example components discussed for the various example cables illustrated in FIGS. 1 and 3 can be incorporated into the cable of FIG. 2. As desired, a cable 200 may also include a wide variety of water blocking or water swellable materials, insulating materials, dielectric materials, flame retardants, flame suppressants or extinguishants, gels, and/or other materials. The cable 200 illustrated in FIG. 2 is provided by way of example only. Embodiments of the disclosure contemplate a wide variety of other cables and cable constructions. These other cables may include more or less components than the cable 200 illustrated in FIG. 2. Additionally, certain components may have different dimensions and/or materials than the components illustrated in FIG. 2.

FIG. 3 illustrates a cross-sectional view of a third example cable 300 suitable for PoE applications, such as extended distance PoE applications. As shown, the cable 300 may include a plurality of twisted pairs 305A-D of individually insulated conductors and a jacket 315 formed around the twisted pairs 305A-D. Each of these components may be similar to those discussed above with reference to the cable 100 of FIG. 1. Additionally, the cable 300 may include one or more shielding elements, such as the illustrated overall shield 320 formed around the plurality of twisted pairs 305A-D. Other suitable shielding elements may be incorporated into the cable 300 as desired, and example shielding arrangements are described in greater detail below. The cable 300 may also include an optional separator 325 positioned between the plurality of twisted pairs 305A-D. As desired, the cable can include a wide variety of other components, such as one or more pulling elements, heat dissipation elements, and/or additional conductors.

Similar to the cable 100 of FIG. 1, the cable 300 of FIG. 3 may include twisted pairs 305A-D having larger conductors than conventional twisted pair cables. For example, each of the twisted pairs 305A-D may have conductors that are sized to be equivalent to or larger than 19 AWG conductors or 18 AWG conductors. As another example, each of the twisted pairs 305A-D may have conductors that have diameters that are greater than or equal to 0.0359 inches, 0.0403 inches, or another suitable diameter. Other suitable conductor sizes may be utilized as desired. Additionally, as described in greater detail above with reference to FIG. 1, a wide variety of suitable twist lays may be utilized in conjunction with the twisted pairs 305A-D of the cable 300 illustrated in FIG. 3.

With continued reference to FIG. 3, in certain embodiments, a suitable separator 325, spline, or filler may be positioned between two or more of the twisted pairs 305A-D. In the event that a cable 300 includes a separator 325, the separator 325 may be disposed within the cable core and configured to orient and or position one or more of the twisted pairs 305A-D. The orientation of the twisted pairs 305A-D relative to one another may provide beneficial signal performance. As desired in various embodiments, the separator 325 may be formed in accordance with a wide variety of suitable dimensions, shapes, or designs. For example, the separator 325 may be formed as an X-shaped separator or cross-filler. In other embodiments, a rod-shaped separator, a flat tape separator, a flat separator, a T-shaped separator, a Y-shaped separator, a J-shaped separator, an L-shaped separator, a diamond-shaped separator, a separator having any number of spokes extending from a central point, a separator having walls or channels with varying thicknesses, a separator having T-shaped members extending from a central point or center member, a separator including any number of suitable fins, and/or a wide variety of other shapes may be utilized.

In certain embodiments, the separator 325 may be continuous along a longitudinal length of the cable 300. In other embodiments, the separator 325 may be non-continuous or discontinuous along a longitudinal length of the cable 300. In other words, the separator 325 may be separated, segmented, or severed in a longitudinal direction such that discrete sections or portions of the separator 325 are arranged longitudinally (e.g., end to end) along a length of the cable 300. Use of a non-continuous or segmented separator 325 may enhance the flexibility of the cable 300, reduce an amount of material incorporated into the cable 300, and/or reduce cost.

In certain embodiments, the separator 325 may be characterized as having projections that extend from a central portion or spine. For example, a cross-filler may be viewed as having a plurality of projections that extend in different directions from a central portion, spine, or central point. In certain embodiments, the projections of a separator 325 may be continuous along a longitudinal length of the separator 325 (or a separator section in a severed separator). In other embodiments, one or more projections of a separator 325 may have sections or portions that are spaced along a longitudinal length of the separator 325, and any suitable longitudinal gap or spacing may be positioned between longitudinally adjacent sections of a projection. Longitudinal gaps utilized between sections of a projection may have any suitable lengths or sized, and gaps may be approximately equal in length and/or spacing (e.g., arranged in accordance with a desired pattern, etc.) or alternatively, arranged in a random or pseudo-random manner. The use of longitudinal spaces between adjacent sections of a projection or between adjacent sets of projections (e.g., spaced grouping of projections or prongs) may facilitate a reduction in material utilized to form the separator 325 and/or may enhance the flexibility of the separator 325.

In certain embodiments, projections may extend from a central portion in different sets of one or more directions at longitudinally spaced locations. For example, a first set of one or more projections may extend in a first set of respective directions. A second set of one or more projections longitudinally adjacent to the first set may extend in a second set of respective directions, and at least one direction of extension in the second set may be different than the direction(s) of extension included in the first set. Regardless of whether longitudinal gaps are positioned between various sets of longitudinally spaced projections, any suitable number of projections (e.g., one, two, three, four, etc.) may extend at each longitudinally spaced location. In certain embodiments, directions of extension may be varied in order to reduce material utilized to form the separator 325 while still providing a separator 325 with a desired overall cross-sectional shape. For example, a separator 325 may function as a cross-filler that includes projections extending in four directions along a longitudinal length; however, at any given location along the longitudinal length, projections may not extend in all four directions. A wide variety of suitable configurations of projections may be utilized as desired. In certain embodiments, a single projection may extend from each longitudinally spaced location, and the projections may alternate directions of extension, for example, at approximately ninety-degree) (90°) angles or in accordance with any other suitable pattern. In other embodiments, two projections may extend from each longitudinally spaced location in opposite directions from a central portion, and the directions of extension may alternate by approximately one hundred and eighty degrees (180°) between adjacent spaced locations. In other embodiments, two projections may extend from each longitudinally spaced location with an approximately ninety-degree (90°) angle between the two projections. The directions of extension for the two projections may then be varied between adjacent longitudinally spaced locations. In yet other embodiments, three projections may extend from each longitudinally spaced location, and a projection that is not present may be alternated or otherwise varied along a longitudinal length. For example, a projection that is not present may be alternated at approximately ninety-degree (90°) angles at adjacent longitudinally spaced locations. Additionally, in certain embodiments, the same number of projections may extend from each of the longitudinally spaced locations. In other examples, different numbers of projections may extend from at least two longitudinally spaced locations. A wide variety of other projection configurations and/or variations may be utilized as desired.

For a cross-filler or other separator 325 that includes projections that extend between adjacent sets of twisted pairs 305A-D, each projection may be formed with a wide variety of suitable dimensions. For example, each projection may have a wide variety of suitable cross-sectional shapes at a given cross-sectional point perpendicular to a longitudinal direction of the separator, cross-sectional shapes taken along the longitudinal direction (e.g., rectangular, square, semi-circular, parallelogram, trapezoidal, triangular, etc.), cross-sectional areas, thicknesses, distances of projection (i.e., length of projection from the central portion), and/or longitudinal lengths. In certain embodiments, each projection may be formed with substantially similar dimensions. In other embodiments, at least two projections may be formed with different dimensions. Similarly, in certain embodiments, each projection may be formed from similar materials. In other embodiments, at least two projections may be formed from different materials.

A wide variety of suitable techniques may be utilized to form a separator 325. For example, in certain embodiments, material may be extruded, cast, molded, or otherwise formed into a desired shape to form the separator 325. In other embodiments, various components of a separator 325 may be separately formed, and then the components of the separator 325 may be joined or otherwise attached together via adhesive, bonding (e.g., ultrasonic welding, etc.), or physical attachment elements (e.g., staples, pins, etc.). In yet other embodiments, a tape may be provided as a substantially flat separator 325 or formed into another desired shape utilizing a wide variety of folding and/or shaping techniques. For example, a relatively flat tape may be formed into an X-shape or cross-shape as a result of being passed through one or more dies. In other embodiments, a plurality of tapes may be combined in order to form a separator 325 having a desired cross-sectional shape. For example, two tapes may be folded at approximately ninety-degree angles and bonded together to form a cross-shaped separator 325. As another example, four tapes may be folded at approximately ninety-degree angles and bonded to one another to form a cross-shaped separator 325. A wide variety of other suitable construction techniques may be utilized as desired. Additionally, in certain embodiments, a separator 325 may be formed to include one or more hollow cavities that may be filled with air or some other gas, one or more additional wires and/or pulling elements, moisture mitigation material, a drain wire, shielding, or some other appropriate components.

The separator 325 (and/or various segments, projections, and/or other components of the separator) may be formed from a wide variety of suitable materials and/or combinations of materials as desired in various embodiments. For example, the separator 325 may include paper, metallic material (e.g., aluminum, ferrite, etc.), alloys, semi-conductive materials, ferrite ceramic materials, various plastics, one or more polymeric materials, one or more polyolefins (e.g., polyethylene, polypropylene, etc.), one or more fluoropolymers (e.g., fluorinated ethylene propylene (“FEP”), melt processable fluoropolymers, MFA, PFA, ethylene tetrafluoroethylene (“ETFE”), ethylene chlorotrifluoroethylene (“ECTFE”), etc.), one or more polyesters, polyvinyl chloride (“PVC”), one or more flame retardant olefins (e.g., flame retardant polyethylene (“FRPE”), flame retardant polypropylene (“FRPP”), a low smoke zero halogen (“LSZH”) material, etc.), polyurethane, neoprene, cholorosulphonated polyethylene, flame retardant PVC, low temperature oil resistant PVC, flame retardant polyurethane, flexible PVC, or any other suitable material or combination of materials. As desired, the separator 325 may be filled, unfilled, foamed, solid, homogeneous, or inhomogeneous and may or may not include additives (e.g., flame retardant and/or smoke suppressant materials). In certain embodiments, a separator 325 may include or incorporate one or more shielding materials, such as electrically conductive shielding material, semi-conductive material, and/or dielectric shielding material (e.g., ferrite ceramic material, etc.). As a result of incorporating electrically conductive material, the separator 325 may function as a shielding element.

In certain embodiments, each segment of a severed or subdivided separator 325 may be formed from similar materials. In other embodiments, a separator 325 may make use of alternating materials in adjacent portions or segments. For example, a first portion or segment of the separator 325 may be formed from a first set of one or more materials, and a second portion or segment of the separator 325 may be formed from a second set of one or more materials. As one example, a relatively flexible material may be utilized in every other portion of a separator 325. As another example, flame retardant material may be selectively incorporated into desired portions of a separator. In this regard, material costs may be reduced while still providing adequate flame retardant qualities.

Additionally, in certain embodiments, one or more separator elements (not shown) may be positioned between the individual conductors of a twisted pair (generally referred to as twisted pair 305). As desired, shielding material may be optionally incorporated into one or more separator elements positioned between the conductors of respective twisted pairs 305A-D. In certain embodiments, a twisted pair separator may be woven helically with the individual conductors or conductive elements of an associated twisted pair 305. In other words, a separator element may be helically twisted with the conductors of a twisted pair 305 along a longitudinal length of the cable 300.

Each separator element may have a wide variety of suitable constructions, components, and/or cross-sectional shapes. For example, each separator may be formed as a dielectric film that is positioned between the two conductors of a twisted pair 305. In other embodiments, a separator may be formed with an H-shape, an X-shape, or any other suitable cross-sectional shape. For example, the separator may be formed to create or define one or more channels in which the twisted pair conductors may be situated. In this regard, the separator may assist in maintaining the positions of the twisted pair conductors when stresses are applied to the cable, such as pulling and bending stresses. Additionally, in certain embodiments, a separator may include a first portion positioned between the conductors of a twisted pair 305 and one or more second portions that form a shield around an outer circumference of the twisted pair. The first portion may be helically twisted between the conductors, and the second portion(s) may be helically twisted around the conductors as the separator and the pair 305 are twisted together. The first portion or dielectric portion may assist in maintaining spacing between the individual conductors of the twisted pair 305 and/or maintaining the positions of one or both of the individual conductors. The second portion(s) or shielding portions may extend from the first portion, and the second portion(s) may be individually and/or collectively wrapped around the twisted pair conductors in order to form a shield layer. 2

A wide variety of other suitable components may be incorporated into the cable 300 of FIG. 3 as desired in other embodiments. Examples of suitable components include, but are not limited to, additional or alternative shielding elements, a rip cord, one or more drain wires, one or more additional wires and/or pulling elements (as described above with reference to FIG. 2), and/or other suitable components. It will be appreciated that any of the example components discussed for the various example cables illustrated in FIGS. 1 and 2 can be incorporated into the cable of FIG. 3. As desired, a cable 300 may also include a wide variety of water blocking or water swellable materials, insulating materials, dielectric materials, flame retardants, flame suppressants or extinguishants, gels, and/or other materials. The cable 300 illustrated in FIG. 3 is provided by way of example only. Embodiments of the disclosure contemplate a wide variety of other cables and cable constructions. These other cables may include more or less components than the cable 300 illustrated in FIG. 3. Additionally, certain components may have different dimensions and/or materials than the components illustrated in FIG. 3.

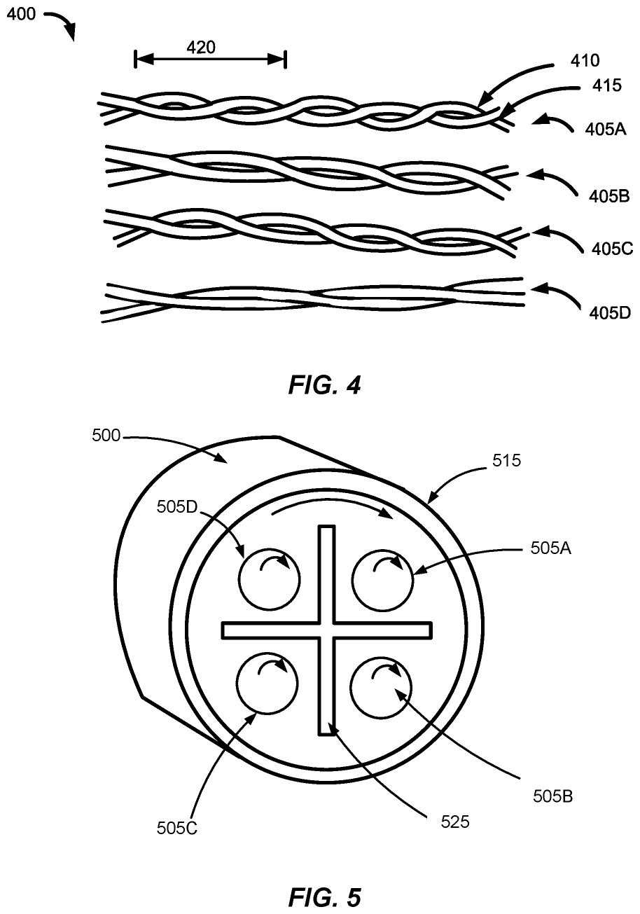

FIG. 4 illustrates a plurality of conductors 400 that are twisted together to form a plurality of twisted pairs that may be utilized in various embodiments of the disclosure. A cable, such as any of the cables 100, 200, 300 illustrated in FIGS. 1-3, may include a plurality of twisted pairs. For example, four twisted pairs 405A-D may be formed from a plurality of conductors 400, and the twisted pairs 405A-D may be incorporated into a cable. Each twisted pair (generally referred to as twisted pair 405) may include two conductors 410, 415, that are twisted around each other or twined together in a suitable twist direction. The two conductors 410, 415 may be twisted together with any suitable twist lay 420, which is the longitudinal length required for the two conductors 410, 415 to make a complete twist around one another.

In certain embodiments, at least two of the twisted pairs 405A-D may have different respective twist lays. For example, a first pair 405A may have a first twist lay and a second pair 405B may have a second twist lay different from the first twist lay. In other embodiments, each of the twisted pairs 405A-D may have a different twist lay. As explained in greater detail above with reference to FIG. 1, a wide variety of suitable twist lays may be utilized as desired in various embodiments.

FIG. 5 illustrates an example cable core 500 in which a plurality of twisted pairs 505A-D are twisted together with an overall twist direction or bunch lay, according to illustrative embodiments of the disclosure. As shown, each of the twisted pairs 505A-D may be twisted in a similar direction, such as a clockwise direction. Additionally, the plurality of twisted pairs 505A-D may be twisted together in an overall twist direction that matches that of each of the twisted pairs (i.e., the same direction). In other embodiments, one or more of the twisted pairs 505A-D may have a twist direction that is opposite that of the overall twist direction. With additional reference to FIG. 5, in certain embodiments, a separator 510 may be positioned between two or more of the plurality of twisted pairs 505A-D. Additionally, one or more wrap or sheath layers 515, such as an overall shield layer and/or a jacket layer may be formed around the plurality of twisted pairs 505A-D.

As set forth above, in certain embodiments, one or more shielding elements, such as one or more shield layers and/or a shielding separator, may be incorporated into a cable. A shield layer may be formed with any number of suitable layers of material and/or layer configurations. FIGS. 6A-6C illustrate cross-sectional views of example tapes or flexible structures that may be utilized to form certain shield elements, according to illustrative embodiments of the disclosure. FIG. 6A illustrates an example tape or flexible structure 600 that includes one or more patches of electrically conductive material 605 (or other shielding material) formed on a dielectric layer 610. Gaps or spaces may exist between adjacent patches along a longitudinal length of the structure 600. FIG. 6B illustrates an example tape or flexible structure 620 in which electrically conductive material (or other shielding material) is formed on opposite sides of a dielectric layer 625. As shown, first electrically conductive material 630 may be formed on a first surface or side of the dielectric layer 625, and the electrically conductive material 630 may include discontinuous patches of material with spaces or gaps formed between adjacent patches. Additional or second electrically conductive material 635 may be formed on an opposite surface or side of the dielectric layer 625. For example, patches of electrically conductive material may be formed on an opposite side of the dielectric layer 625 to cover gaps between adjacent patches formed on the first side. FIG. 6C illustrates another example tape or flexible structure 640 in which electrically conductive material 645 (or other shielding material) is sandwiched between two suitable dielectric layers 650, 655. A wide variety of other constructions may be utilized as desired to form a shield element. For example, solid electrically conductive material may be utilized to form a shield layer. As another example, longitudinally continuous electrically conductive material may be formed on a dielectric layer. Indeed, any number of dielectric, electrically conductive, shielding, and/or other layers may be utilized in a shielding element. The constructions illustrated in FIGS. 6A-6C are provided by way of example only.

Additionally, a wide variety of different electrically conductive patch configurations or other configuration of shielding material may be utilized in conjunction with shielding elements, such as shield layers. FIGS. 7A-7C illustrate top level views of example tape or flexible structures that may be utilized to form certain shield elements. With reference to FIG. 7A, a top-level view of a first example flexible structure 700 is illustrated. The structure 700 may include any number of rectangular patches of electrically conductive material (or other shielding material), such as patches 705A-D formed on a dielectric material. As desired in various embodiments, the patches 705A-D may include any desired lengths, and any desired gap 710 or separation distance may be provided between adjacent patches. In certain embodiments, the patches may be formed in accordance with a repeating pattern having a definite step or period. As desired, additional patches may be formed on an opposing side of the dielectric material to cover the gaps 710. Additionally, in certain embodiments, each patch 705A-D may have a width that spans across the structure 700. In other embodiments, other patch widths may be utilized. For example, a plurality of discontinuous patches may be positioned across a width dimension of the structure 700.

FIG. 7B illustrates a top-level view of another example flexible structure 720 that may be utilized in the formation of a shield element. The flexible structure 720 may include any number of electrically conductive patches (or patches formed from other shielding material) having the shape of a parallelogram. In other words, the patches may be formed at an angle within one or more areas of the structure 720. As shown, the patches may be formed at an acute angle with respect to the width dimension of the structure 720. In certain embodiments, the acute angle facilitates manufacturing and enhances patch-to-substrate adhesion. Additionally, the acute angle may also facilitate the covering of opposing isolating spaces or gaps. In certain embodiments, benefit may be achieved when the acute angle is about 45 degrees or less. In other embodiments, benefit is achieved when the acute angle is about 35 degrees or less, about 30 degrees or less, about 25 degrees or less, about 20 degrees or less, or about 15 degrees or less. In other embodiments, benefit is achieved when the acute angle is between about 12 and 40 degrees. In certain embodiments, the acute angle may be in a range between any two of the degree values provided in this paragraph.

FIG. 7C illustrates a top-level view of another example flexible structure 730 that may be utilized in the formation of a shielding element. The structure 730 may include any number of electrically conductive patches (or patches of another shielding material) having a trapezoidal shape. In certain embodiments, the orientation of adjacent trapezoidal patches may alternate. Similar to the patch pattern illustrated in FIG. 7B, the trapezoidal patches may provide manufacturing and/or shielding benefits. A wide variety of other suitable patch configurations may be utilized as desired in various embodiments. For example, triangular, square, and/or other patches may be utilized. As another example, a structure may be formed with relatively continuous shielding material either with or without a dielectric substrate layer.

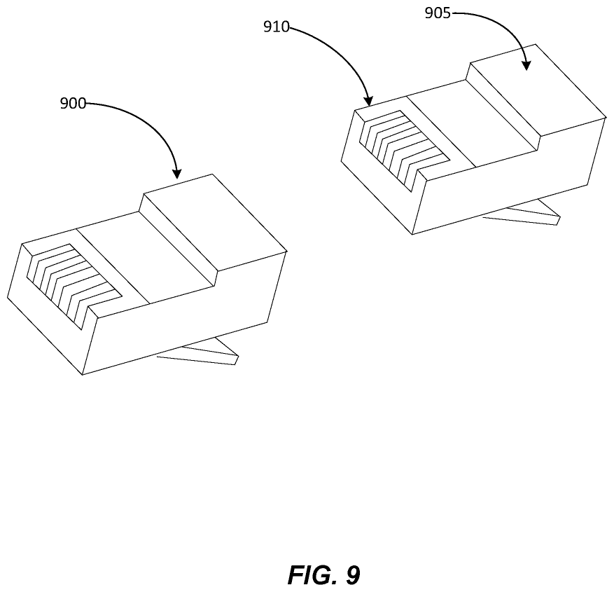

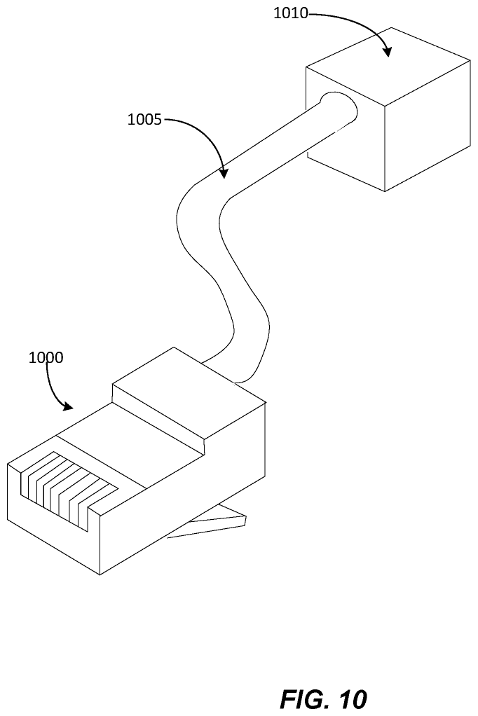

According to an aspect of the disclosure, the four twisted pairs included in a cable, such as any of the cables 100, 200, 300 of FIGS. 1-3, may also be electrically connected to an RJ-45 connector. A wide variety of methods and/or techniques may be utilized as desired to connect the twisted pairs or a cable to an RJ-45 connector, wherein the RJ-45 connector is configured to be plugged into a standard RJ-45 or Ethernet port. FIGS. 8-10 are perspective views of example RJ-45 connectors at which twisted pair cables may be electrically terminated, according to illustrative embodiments of the disclosure. More particularly, FIG. 8 illustrates an example RJ-45 connector 800 that may be adapted to receive the conductors of the twisted pairs. In other words, the twisted pairs may be directed terminated to the RJ-45 connector 800. FIG. 9 illustrates an example RJ-45 connector 900 configured to receive an adapter, and the twisted pairs may be terminated at the adapter. FIG. 10 illustrates an example RJ-45 connector 1000 that may be in electrical communication with the twisted pairs via a jumper cable. Each of the example connectors of FIGS. 8-10 are described in greater detail below. Additionally, it will be appreciated that the described connectors are provided by way of non-limiting example only and other connector designs or configurations may be utilized in other embodiments.

Turning first to FIG. 8, a perspective view of first example RJ-45 connector 800 that may be electrically connected to a twisted pair cable having larger conductors (e.g., 19 AWG, 18 AWG, or larger conductors) is illustrated. The connector 800 may include certain components similar to those of a conventional RJ-45 connector. For example, the connector 800 may include a housing 805 made of any suitable plastic or polymeric material(s) (e.g., polycarbonate, etc.). The housing 805 may generally define the outer dimensions of the connector 800, and the housing may be sized such that the connector 800 may be inserted into and received by a conventional RJ-45 or Ethernet jack or plug. The housing 805 may include any suitable plurality of surfaces or sides, such as a top, bottom, left side, right side, and front surface. Additionally, a suitable latch 810 may extend from the housing 805, and the latch 810 may facilitate holding the connector 800 within a suitable jack or plug in a releasable manner. The connector 800 may also include a shield (not shown) formed from any suitable shielding material and/or combination of shielding materials, such as a metallic material (e.g., copper foil, etc.). The shield may be formed or shaped around the connector 800 (e.g., shaped around an inner surface of the housing 805, etc.), and the shield may reduce electromagnetic interference on the conductors terminated at the connector 800.

With continued reference to FIG. 8, the connector 800 may include a plurality of contacts 815 or pins that may be placed into electrical contact with the conductors of a twisted pair. For example, the connector 800 may include eight contacts 815 with each contact configured to be connected to a respective conductor of a four pair cable. In certain embodiments, the connector 800 may include insulation displacement elements or prongs (not shown) associated with each contact. When a conductor is inserted into the connector 800, a prong may be pressed into the conductor, thereby piercing the insulation of the conductor and creating electrical contact between the conductor and the contact. The contacts and prongs of the connector 800 may be formed from a wide variety of suitable materials, such as gold-plated bronze, gold-plated copper, copper, or any other suitable electrically conductive material.

In certain embodiments, the connector 800 may include internal guides configured to align the conductors of a twisted pair with respective contacts and/or prongs. When a conductor is positioned within an internal guide, a prong may pierce the insulation of the conductor when crimped onto the conductor. Additionally, as desired, the connector 800 may include a suitable insert 820 that includes channels 825 into which each of the conductors of a twisted pair may be positioned. In operation, the conductors of a twisted pair may be positioned within the insert 820 while the insert 820 is outside the connector 800, and the insert 820 may then be pushed into the connector 800 (i.e., inserted into a back of the connector 800). The insert 820 may have outer dimensions that facilitate its insertion into the connector 800 such that the channels 825 are aligned with the guides of the connector 800. According to an aspect of the disclosure, the guides and the channels 825 of the connector 800 shown in FIG. 8 may be sized to receive larger conductors of a twisted pair cable, such as 19 AWG, 18 AWG, or larger conductors. In certain embodiments, the guides and the channels 825 may be sized to receive larger insulated conductors. In other embodiments, the guides and the channels 825 may be sized to receive 825 conductors after insulation has been stripped from the conductors. In such embodiments, the guides and the channels 825 may maintain electrical isolation between the various conductors. Regardless of whether insulation displacement contacts are used or, alternatively, stripped conductors are positioned within a connector 800, if the conductors of a twisted pair are directly connectors to the contacts of the connector 800, then the contacts form or constitute a termination block within the connector 800 for the twisted pair conductors.

In certain embodiments, the connector 800 may additionally include a strain relief clamp 830 or collar. Following insertion of a twisted pair cable into the connector 800, the clamp 830 may be crimped around the cable to assist in holding the cable in place and to provide strain relief.

FIG. 9 illustrates a perspective view of second example RJ-45 connector 900 that may be electrically connected to a twisted pair cable having larger conductors (e.g., 19 AWG, 18 AWG, or larger conductors). The connector 900 of FIG. 9 may include components that are similar to those of a conventional RJ-45 connector. In other words, the connector 900 may not be adapted to directly receive larger conductors (e.g., 19 AWG, 18 AWG, or larger conductors) and, as such, the conductors may not be directly terminated at the connector 900. Instead, an adapter 905 may be utilized to facilitate electrical connection of a twisted pair cable to the connector 900. The conductors of the twisted pair cable may be terminated at the adapter 905, and the adapter 905 may be plugged into or otherwise connected to or terminated at the connector 900, thereby facilitating electrical connection of the twisted pair conductors to the contacts of the connector 900.

In certain embodiments, the adapter 905 may be sized to receive the larger conductors of the twisted pair cable. For example, the adapter 905 may include guides and/or channels into which the conductors may be inserted such that the conductors are terminated at suitable contacts or another suitable termination block of the adapter 905. Similar to the connector 800 described above with reference to FIG. 8, the adapter 905 may optionally include an insert having channels sized to receive larger conductors. The adapter 905 may also include internal guides sized to receive the conductors. As desired in certain embodiments, the adapter 905 may include suitable insulation displacement pins or prongs that facilitate termination of the conductors to contacts of the adapter 905. In other embodiments, the conductors may be stripped prior to termination at the adapter 905. The adapter 905 may further include a suitable end portion 910 or plug that is sized or dimensioned such that it may be inserted into or positioned within the RJ-45 connector 900. For example, the contacts of the adapter 905 may be aligned with and electrically terminated to the contacts of the RJ-45 connector 900. In this regard, the adapter may facilitate electrical connection of the conductors to the RJ-45 connector 900.

FIG. 10 illustrates a perspective view of third example RJ-45 connector 1000 that may be electrically connected to a twisted pair cable having larger conductors (e.g., 19 AWG, 18 AWG, or larger conductors). The connector 1000 of FIG. 10 may include components that are similar to those of a conventional RJ-45 connector. In other words, the connector 1000 may not be adapted to directly receive larger conductors (e.g., 19 AWG, 18 AWG, or larger conductors) and, as such, the conductors may not be directly terminated at the connector 1000. Instead, a jumper cable 1005 may be utilized to facilitate electrical connection of a twisted pair cable to the connector 1000. The jumper cable 1005 may include a plurality of conductors that are respectively associated with an connected to the conductors of the twisted pair, and the jumper cable 1005 conductors may be terminated at the RJ-45 connector 1000.

As desired, a suitable adapter 1010 may be utilized to facilitate connection of the twisted pair cable to the jumper cable 1005. The conductors of the twisted pair cable may be terminated to one side of the adapter 1010, and the jumper cable 1005 may be terminated to an opposite side of the adapter 1010. In certain embodiments, a first portion of the adapter 1010 may be sized to receive the larger conductors of the twisted pair cable. For example, the adapter 1010 may include guides and/or channels into which the conductors may be inserted such that the conductors are terminated at suitable contacts or another suitable termination block of the adapter 1010. As desired in certain embodiments, the adapter 1010 may include suitable insulation displacement pins or prongs that facilitate termination of the conductors to contacts of the adapter 1010. In other embodiments, the conductors may be stripped prior to termination at the adapter 1010. The adapter 1010 may further include a second portion configured to be connected to the jumper cable 1005. For example, the second portion may include a termination block sized to receive the conductors of the jumper cable 1005. Additionally, the jumper cable termination block may be in electrical connection with the twisted pair cable termination block, thereby facilitating electrical contact between the twisted pair cable and the jumper cable and further electrical contact between the twisted pair cable and the RJ-45 connector 1000.

A wide variety of other suitable RJ-45 or RJ-45 style connectors may be utilized in association with twisted pair cable as desired in other embodiments. These connectors may have more or less components than the example connectors described above with reference to FIGS. 8-10. It will be appreciated that the connectors described herein are provided by way of non-limiting example only.

Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or operations. Thus, such conditional language is not generally intended to imply that features, elements, and/or operations are in any way required for one or more embodiments or that one or more embodiments necessarily include logic for deciding, with or without user input or prompting, whether these features, elements, and/or operations are included or are to be performed in any particular embodiment.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A cable, comprising:
four twisted pairs of individually insulated conductors, each of the four twisted pairs comprising two conductors having a size greater than or equal to a 19 American Wire Gauge conductor;
a jacket formed around the four twisted pairs; and
an RJ-45 connector, wherein the four twisted pairs are electrically connected to the RJ-45 connector,
wherein the cable has a longitudinal length greater than 100 m.

2. The cable of claim 1, wherein the two conductors of each of the four twisted pairs has a size greater than or equal to an 18 American Wire Gauge conductor.

3. The cable of claim 1, wherein the two conductors of each of the four twisted pairs has a diameter greater than or equal to 0.0359 inches.

4. The cable of claim 1, wherein the two conductors of each of the four twisted pairs has a diameter greater than or equal to 0.0403 inches.

5. The cable of claim 1, wherein the RJ-45 connector comprises a housing and a termination block positioned within the housing, and
wherein the four twisted pairs are terminated at the termination block.

6. The cable of claim 1, further comprising an adapter configured to be electrically connected to the RJ-45 connector, wherein the four twisted pairs are terminated at the adapter.

7. The cable of claim 1, further comprising a jumper cable configured to electrically connect the four twisted pairs to the RJ-45 connector.

8. The cable of claim 1, wherein the four twisted pairs are configured to transmit 100 Watts at 1.0 ampere per pair over a distance of at least 100 meters.

9. The cable of claim 1, wherein the cable has a diameter of less than 10 mm.

10. A cable, comprising:
four twisted pairs of individually insulated conductors, each of the four twisted pairs comprising two conductors having a diameter greater than or equal to 0.0359 inches;
a jacket formed around the four twisted pairs; and
an RJ-45 connector, wherein the four twisted pairs are electrically connected to the RJ-45 connector,
wherein the cable has a longitudinal length greater than 100 m.

11. The cable of claim 9, wherein the two conductors of each of the four twisted pairs has a diameter greater than or equal to 0.0403 inches.

12. The cable of claim 9, wherein the RJ-45 connector comprises a housing and a termination block positioned within the housing, and
wherein the four twisted pairs are terminated at the termination block.

13. The cable of claim 9, further comprising an adapter configured to be electrically connected to the RJ-45 connector, wherein the four twisted pairs are terminated at the adapter.

14. The cable of claim 9, further comprising a jumper cable configured to electrically connect the four twisted pairs to the RJ-45 connector.

15. The cable of claim 9, wherein the four twisted pairs are configured to transmit 100 Watts at 1.0 ampere per pair over a distance of at least 100 meters.

16. The cable of claim 9, wherein the cable has a diameter of less than 10 mm.

17. A cable, comprising:
four twisted pairs of individually insulated conductors, each of the four twisted pairs comprising two conductors having a size greater than or equal to an 18 American Wire Gauge conductor;
a jacket formed around the four twisted pairs; and
an RJ-45 connector, wherein the four twisted pairs are electrically connected to the RJ-45 connector,
wherein the cable has a longitudinal length greater than 100 m.

18. The cable of claim 17, wherein the RJ-45 connector comprises a housing and a termination block positioned within the housing, and
wherein the four twisted pairs are terminated at the termination block.

19. The cable of claim 17, further comprising an adapter configured to be electrically connected to the RJ-45 connector, wherein the four twisted pairs are terminated at the adapter.

20. The cable of claim 17, further comprising a jumper cable configured to electrically connect the four twisted pairs to the RJ-45 connector.
